(19) United States
(12) Patent Application Publication
(10) Pub. No.: US 2005/0038939 A1
(43) Pub. Date: Feb. 17, 2005

(54) Data interfacing apparatus and method of a network electronic device

(75) Inventor: Hyuck-Jae Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/873,829

(22) Filed: Jun. 16, 2004

(30) Foreign Application Priority Data
Jun. 19, 2003 (KR) 2003-39889

(51) Int. Cl. G06F 13/00

(52) U.S. Cl. 710/33

(57) ABSTRACT

A data interfacing apparatus and method of a network electronic device are provided. The data interfacing apparatus includes a data receiving unit to receive execution packet data to execute functions of the a network electronic device data and control packet data to control the network electronic device from a host via a network; a data storage controlling unit to control storage of the execution packet data and/or the control packet data; a data storage unit to store the execution packet data and/or the control packet data; a network processing unit to generate transfer descriptors of the execution packet data stored in the data storage unit and/or generate a control block of the control packet data stored in the data storage unit; and an interface controlling unit to transmit packet data corresponding to the transfer descriptors to the network electronic device through direct memory access and/or transmit packet data corresponding to the control block to the network electronic device, and to receive response packet data from the network electronic device as a response to the control packet data. Accordingly, data is transmitted between a network electronic device and the data interfacing apparatus at high speeds by reducing local bus bandwidth occupancy rates of the network electronic device and the data interfacing apparatus. In addition, it is possible to simplify codes and minimize header information by using a streaming channel through direct memory access to skip pretreatment operations to interpret command languages.

### CROSS-REFERENCE TO RELATED APPLICATION

This application claims the priority of Korean Patent Application No. 2003-39889, filed on Jun. 19, 2003 in the Korean Intellectual Property Office, the disclosure of which is incorporated herein in its entirety by reference.

### BACKGROUND OF THE INVENTION

1. Field of the Invention

The present invention relates to a network electronic device, such as a printer, a facsimile machine, or a multi-functional device, with which a copy machine, a printer, a scanner, and/or other similar devices are integrated, and more particularly, to a data interfacing apparatus and method of a network electronic device to enable data to be transmitted between the network electronic device and a host at high speeds.

2. Description of the Related Art

Generally, there are two data interfacing methods used to transmit data between a network electronic device and a host, a method of using a dual processor system and a method of using a single processor system. The dual processor system includes: a network card exclusively used for network electronic devices, having a protocol processor to secure a local bus bandwidth for a main controller of a network electronic device; and a shared memory to serve as a buffer to transmit data on the network electronic device and to transmit data to control the network electronic device and the main controller of the network electronic device. The single processor system includes a commonly used network card having external bus specifications (e.g., a peripheral component interconnect (PCI) external bus), and the main controller of the network electronic device. However, for high-speed network interfacing, the dual processor system is more widely adopted than the single processor system.

The method of using the dual processor system will now be described in greater detail, using a network printer as an example of a network electronic device. Printing data transmitted from a host via a network is input to a printer network card and converted to printing language data by removing header information of a network protocol from the printing data. The printing language data is packetized and stored in a shared memory. The shared memory is a dual port memory, which serves as an inter-process communication (IPC) buffer for a multiprocessor, and generally has a relatively smaller storage capacity than program memories. Since the printing language data is too large to be stored in the shared memory at one time, the printing language data is transmitted using a ring buffer structure.

The network printer performs control operations, such as checking the state of the host and changing setting values, etc., in addition to the above-described printing operations, by using control data transmitted between the printer network card and the network printer. The control data and the printing data may be separately transmitted between the printer network card and the network printer using different channels and/or may be multiplexed and transmitted together between the printer network card and the network printer using one channel based on the importance of the control data.

One of the most widely adopted IPC methods using a multiprocessor is an IPC method using a shared memory, which allows the structure of a system to be flexibly modified to a certain extent. However, the IPC method may not be able to provide high-speed data transmissions. In other words, the IPC method adds operational codes and headers having size information to the electronic device data, such as printing data, in order to use a shared memory channel, which results in a considerable amount of overhead. In addition, in order to transmit the electronic device data, which is streaming data, the IPC method needs a command cycle of a processor that narrows a local bus bandwidth of a program memory, e.g., a dynamic random access memory (DRAM), and a bandwidth of a command bus of the processor. Moreover, a program looping operation is necessary to read and/or to write packet data using a shared memory. However, the command cycle is at least ten times longer than a shared memory cycle, and thus the entire speed of accessing the shared memory decreases.

### SUMMARY OF THE INVENTION

An aspect of the present invention provides a data interfacing apparatus of a network electronic device to enable data to be transmitted between a network electronic device and the data interfacing apparatus at high speeds by reducing local bus bandwidth occupancy rates of the network electronic device and the data interfacing apparatus.

An aspect of the present invention provides a data interfacing method of a network electronic device.

Additional aspects and/or advantages of the invention will be set forth in part in the description which follows and, in part, will be obvious from the description, or may be learned by practice of the invention.

According to an aspect of the present invention, a data interfacing apparatus of a network electronic device is provided. The data interfacing apparatus includes: a data receiving unit to receive execution packet data to execute functions of the network electronic device and control packet data to control the network electronic device from a host via a network; a data storage controlling unit to control storage of the execution packet data and/or the control packet data; a data storage unit to store the execution packet data and/or the control packet data; a network processing unit to generate transfer descriptors of the execution packet data stored in the data storage unit and/or generate a control block of the control packet data stored in the data storage unit; and an interface controlling unit to transmit packet data corresponding to the transfer descriptors to the network electronic device through direct memory access and/or transmit packet data corresponding to the control block to the network electronic device, and to receive response packet data from the network electronic device as a response to the control packet data.

According to another aspect of the present invention, a data interfacing method of a network electronic device via a data interface apparatus of the network electronic device is provided. The data interfacing method comprises: receiving execution packet data to execute functions of the network electronic device from a host; generating transfer descriptors of the execution packet data; and transmitting the execution packet data corresponding to the transfer descriptors to the network electronic device through direct memory access.

According to another aspect of the present invention, a data interfacing method of a network electronic device via a data interfacing apparatus of the network electronic device is provided. The data interfacing method includes: receiving control packet data to control a network electronic device from a host; generating a control block of the control packet data; and transmitting the control packet data corresponding to the control block to the network electronic device and receiving response packet data from the network electronic device as a response to the control packet data.

### BRIEF DESCRIPTION OF THE DRAWINGS

The above and/or other aspects and advantages of the invention will become more apparent, and more readily appreciated from the following description of the preferred embodiments, taken in conjunction with the accompanying drawings of which:

FIG. 1 is a block diagram of a data interfacing apparatus of a network electronic device according to an aspect of the present invention;

FIG. 2 is a diagram to illustrate execution packet data, each with a header, and connected with a chain of transfer descriptors;

FIG. 3A is a diagram to illustrate execution packet data stored in a data storage unit of FIG. 1;

FIG. 3B is a diagram to illustrate control packet data stored in the data storage unit of FIG. 1;

FIG. 4 is a diagram to illustrate a transfer descriptor according to an aspect of the present invention;

FIGS. 5A and 5B is a diagram to illustrate a read and write control block according to an aspect of the present invention;

FIG. 6 is a detailed block diagram of an interface controlling unit of FIG. 1;

FIG. 7 is a diagram to illustrate a first channel controller of FIG. 6 and exemplary transfer descriptors checked by the first channel controller;

FIG. 8 is a diagram to illustrate serialized execution packet data transmitted to and stored in a network electronic device;

FIG. 9 is a timing diagram to illustrate serialized packet data transmitted to a network electronic device;

FIGS. 10A through 10D are diagrams to illustrate various data blocks stored in a register of FIG. 6;

FIG. 11 is a timing diagram to illustrate control packet data transmitted to a network electronic device;

FIG. 12 is a diagram to illustrate control packet data and/or response data packet transmitted to a network electronic device in response to an interrupt signal;

FIG. 13 is a flowchart of a data interfacing method of a network electronic device according to an aspect of the present invention;

FIG. 14 is a detailed flowchart of operation 504 of FIG. 13;

FIG. 15 is a flowchart of a data interfacing method of a network electronic device according to another aspect of the present invention;

FIG. 16 is a detailed flowchart of operation 702 of FIG. 15; and

FIG. 17 is a detailed flowchart of operation 704 of FIG. 15.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

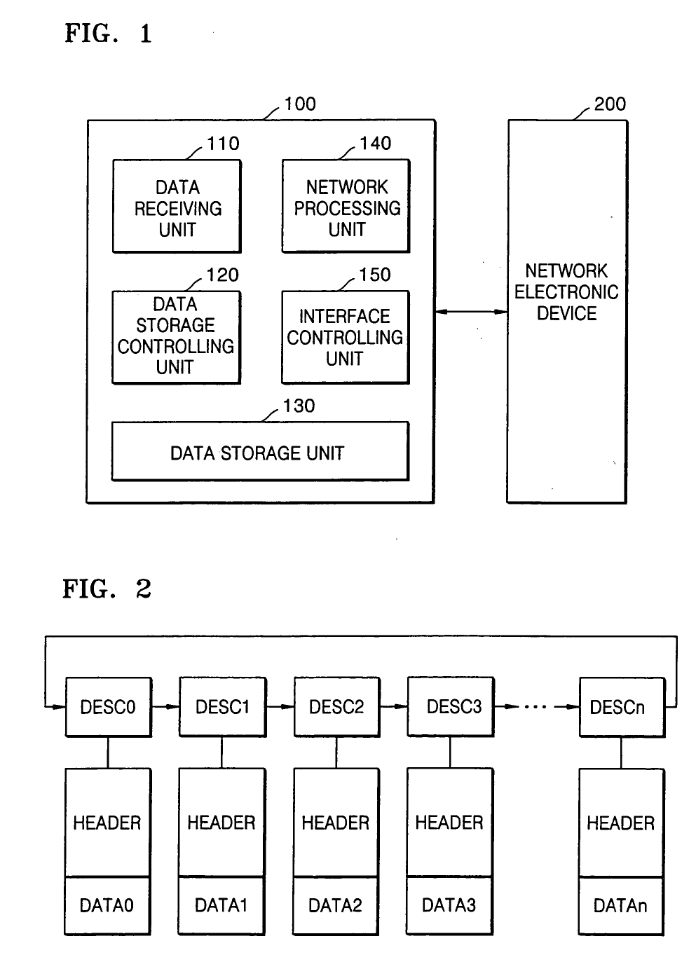

FIG. 1 is a block diagram of a data interfacing apparatus 100 for of a network electronic device 200 according to an aspect of the present invention. Referring to FIG. 1, the data interfacing apparatus 100 is connected with the network electronic device 200.

The data interfacing apparatus 100 includes a data receiving unit 110, a data storage controlling unit 120, a data storage unit 130, a network processing unit 140, and an interface controlling unit 150.

The data receiving unit 110 receives packet data to execute functions of the network electronic device 200 (hereinafter, referred to as execution packet data) and packet data to control the network electronic device 200 (hereinafter, referred to as control packet data) from a host (not shown). The execution packet data assists the network electronic device 200 to perform the functions of the network electronic device 200. For example, when the network electronic device 200 is a printer, the execution packet data may be printing data. According to an aspect of the present invention, control packet data is used to control the network electronic device 200. For example, when the network electronic device 200 is a printer, the control packet data is used to read and/or set attributes of the printer. According to an aspect of the present invention, the data receiving unit 110 receives the execution packet data from the host by using, for example, a chain buffer comprised of a chain of descriptors and a buffer. FIG. 2 illustrates execution packet data DATA0 through DATAn, each including a header (HEADER) and respectively connected with a chain of descriptors DESC0 through DESCn. According to an aspect of the present invention, the data receiving unit 110 receives the control packet data from the host by using, for example, a simple network management protocol (SNMP), which is a protocol to control the network electronic device 200.

The data storage controlling unit 120 controls the execution packet data and/or the control packet data received from the data receiving unit 110 to be stored in the data storage unit 130.

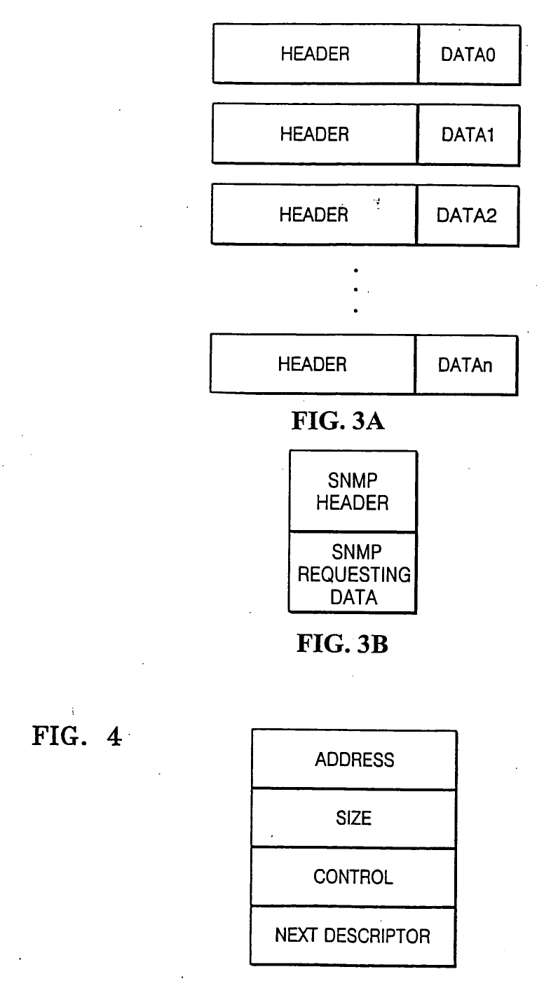

The data storage unit 130 stores the execution packet data and/or control packet data. FIG. 3A illustrates the execution packet data stored in the data storage unit 130, and FIG. 3B illustrates the control packet data stored in the data storage unit 130. For example, when the network electronic device 200 is a printer, the execution packet data includes header information and printing data information, and the control packet data includes header information of the SNMP and control requesting data. According to an aspect of the present invention, the data storage unit 130 is a dynamic random access memory (DRAM), which is a volatile memory that loses data stored therein when power is cut off, and is widely adopted in memory devices having a large storage capacity because of high integration density of the DRAM.

According to an aspect of the present invention, the network processing unit 140 generates transfer descriptors of the execution packet data stored in the data storage unit 130 and/or generates a control block of the control packet data stored in the data storage unit 130. The transfer descriptors facilitate access to the execution packet data stored in the data storage unit 130 because the descriptors have various information of respective execution packet data, such as address information and data size, control information, and adjacent transfer descriptor information of other transfer descriptors connected thereto.

FIG. 4 illustrates a transfer descriptor according to an aspect of the present invention. Referring to FIG. 4, the transfer descriptor includes an address block ADDRESS including address information of a predetermined execution data packet, a size block SIZE including size information of the predetermined execution data packet, a control block CONTROL including control information to control the transmission of the predetermined execution data packet to the network electronic device 200, and a next transfer descriptor block NEXT DESCRIPTOR including information of an execution data packet following the predetermined execution data packet. According to an aspect of the present invention, due to the next transfer descriptor block NEXT DESCRIPTOR, the predetermined transfer descriptor is chained to other transfer descriptors. In other words, the network processing unit 140 creates a chain of transfer descriptors connected with one another. Once execution packet data is transmitted to the network electronic device 200, the network processing unit 140 removes information of the execution packet data from respective transfer descriptors.

According to an aspect of the present invention, network processing unit 140 creates a read control block having address, size, control, and transmission state information of the control packet data stored in the data storage unit 130 and/or creates a write control block having address and size information of a location in which response packet data is to be stored, and control and transmission state information of the response packet data.

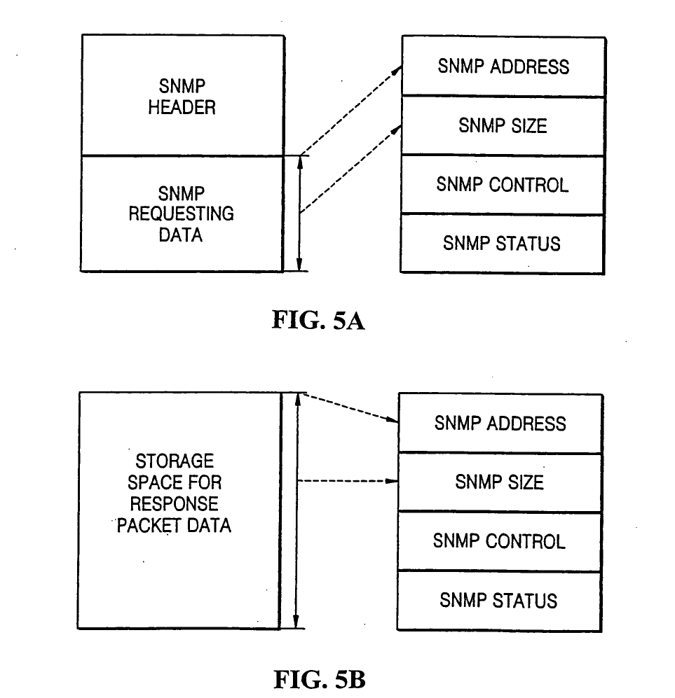

FIG. 5A illustrates an example of the read control block. Referring to FIG. 5A, the read control block includes an SNMP address block SNMP ADDRESS having address information of the control packet data stored in the data storage unit 130, an SNMP size block SNMP SIZE having size information of the control packet data, an SNMP control block SNMP CONTROL having control information to control the transmission of the control packet data to the network electronic device 200, and an SNMP status information block SNMP STATUS having information that indicates whether the control packet data is transmitted to the network electronic device 200. According to an aspect of the present invention, information included in the SNMP address block and the SNMP size block is obtained from the control packet data stored in the data storage unit 130.

Before the network processing unit 140 transmits the control packet data to the network electronic device 200, the network processing unit 140 secures a predetermined space in the data storage unit 130 so that the response data is stored in the predetermined space. The response data includes a response of the network electronic device 200 to the control packet data. The network processing unit 140 secures the predetermined space in the data storage unit 130 in advance so that the data interfacing apparatus 100 receives the control data from the network electronic device 200. FIG. 5B illustrates an example of the write control block. Referring to FIG. 5B, the network processing unit 140 secures a predetermined space in the data storage unit 130 in advance so that the response data is stored in the predetermined space. The write control block includes an SNMP address block SNMP ADDRESS having address information of the predetermined space in the data storage unit 130 where the response data is to be stored, an SNMP size block SNMP SIZE having size information of the predetermined space, an SNMP control block having control information to control the transmission of the response data to the data interfacing apparatus 100, and an SNMP status block having information that indicates whether the response data is input to the data interfacing apparatus 100. According to an aspect of the present invention, information included in the SNMP address block and the SNMP size block is obtained from the predetermined space in the data storage unit 130.

The interface controlling unit 150 transmits the execution packet data corresponding to the transfer descriptors generated by the network processing unit 140 to the network electronic device 200 through direct memory access. According to another aspect of the present invention, the interface controlling unit 150 transmits the control packet data corresponding to the control block generated by the network processing unit 140 to the network electronic device 200, and receives the response data from the network electronic device 200 as a response to the control packet data transmitted to the network electronic device 200.

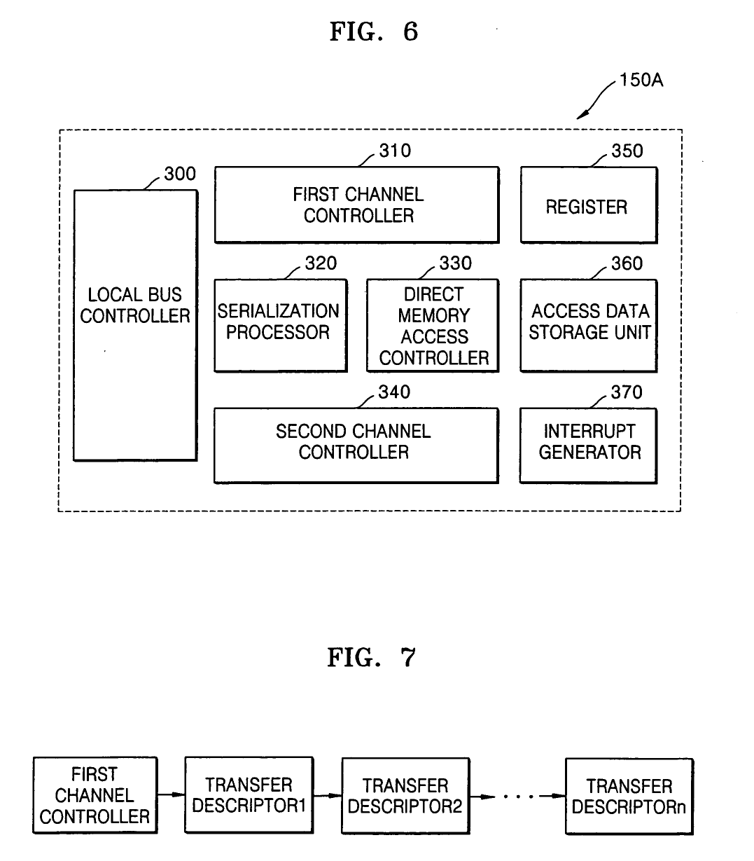

FIG. 6 is a detailed block diagram of the interface controlling unit 150 of FIG. 1. Referring to FIG. 6, the interface controlling unit 150A includes a local bus controller 300, a first channel controller 310, a serialization processor 320, a direct memory access controller 330, a second channel controller 340, a register 350, an access data storage 360, and an interrupt generator 370.

According to an aspect of the present invention, the local bus controller 300 controls transmission of data via a local bus. The local bus controller 300 controls the transmission of data using the local bus that connects the elements of the interface controlling unit 150 with one another. For example, the local bus controller 300 controls the transmission of execution packet data to the network electronic device 200 by allowing the execution packet data to occupy the local bus.

The first channel controller 310 checks transfer descriptors, withdraws execution packet data corresponding to addresses of the transfer descriptors, and outputs the withdrawn execution packet data. FIG. 7 is a diagram to illustrate the first channel controller 310 of FIG. 6 and transfer descriptors 1 through n. Referring to FIG. 7, the first channel controller 310 sequentially checks transfer descriptors generated by the network processing unit 140 and checks whether the transfer descriptors have information related to the execution packet data. Upon determining that the transfer descriptors are determined to have the information related to the execution packet data, the first channel controller 310 withdraws execution packet data corresponding to an address block (shown in FIG. 4) of each of the transfer descriptors from the data storage unit 130 and outputs the withdrawn execution packet data to the serialization processor 320. The withdrawn execution packet data is packet data from which header information has been removed. The first channel controller 310 outputs transmission requesting information of execution packet data to be transmitted to the network electronic device 200 to the direct memory access controller 330.

The serialization processor 320 serializes the execution packet data withdrawn from the data storage unit 130 by the first channel controller 310 and outputs the serialized execution packet data to the direct memory access controller 330. According to an aspect of the present invention, the serialization processor 320 is a first in first out (FIFO) memory that outputs data in an order the data is received. In other words, the serialization processor 320 sequentially receives and serializes execution packet data, from which header information has been removed. Thereafter, the serialization processor 320 outputs the serialized execution packet data to the direct memory access controller 330 in the order received.

The direct memory access controller 330 transmits the serialized execution packet data received from the serialization processor 320 to the network electronic device 200 through direct memory access. Accordingly, direct memory access indicates a predetermined data transmission manner, in which data is directly transmitted between the serialization processor 320 and the network electronic device 200. The network electronic device 200 includes a direct memory access controller (not shown). The network electronic device 200 transmits transmission allowance information that indicates whether access is allowed to the direct memory access controller 330. When the direct memory access controller 330 receives the transmission allowance information from the network electronic device 200, the direct memory access controller 330 transmits the serialized execution packet data to the network electronic device 200 through direct memory access, in which case, the serialized execution packet data does not need a valid address because of the characteristics of a streaming channel.

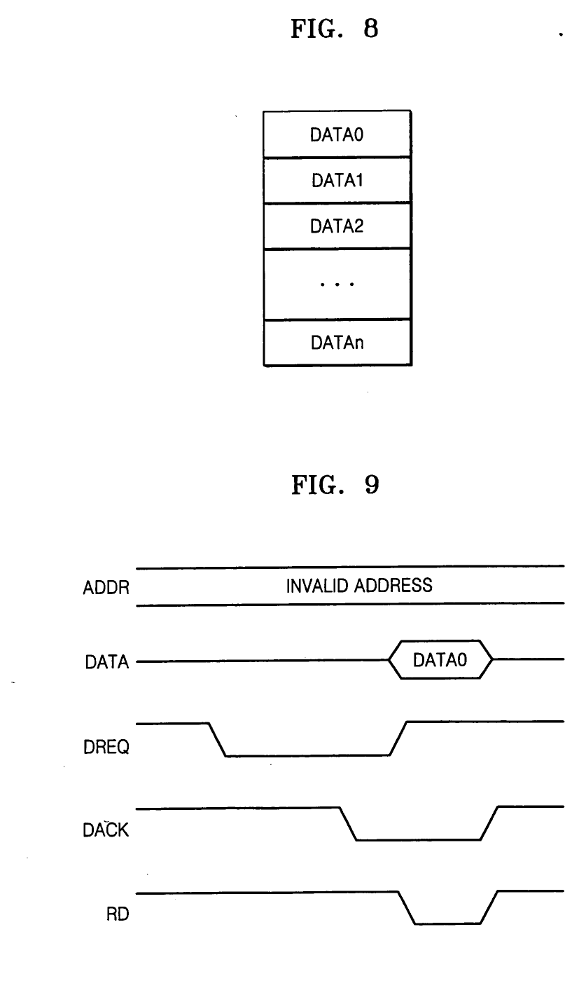

FIG. 8 is a diagram to illustrate serialized execution packet data transmitted to and stored in the network electronic device 200. Referring to FIG. 8, the serialized execution packet data is stored in a predetermined storage space (not shown) in the network electronic device 200. The serialized execution packet data stored in the network electronic device 200 assists the network electronic device 200 to perform functions.

FIG. 9 is a timing diagram to illustrate the transmission of serialized execution packet data to the network electronic device 200. Referring to FIG. 9, an invalid address INVALID ADDRESS is provided as address information ADDR because the serialized execution packet data is transmitted over a streaming channel. The first channel controller 310 creates transmission request information DREQ, outputs the transmission request information DREQ to the network electronic device 200, receives transmission allowance information DASK from the network electronic device 200, and transmits packet data DATA0 to the network electronic device 200 in response to execution of a read command RD.

The register 350 stores a read control block and a write control block generated by the network processing unit 140 and allows the read and/or write control block to be accessed by the second channel controller 340 in response to a request to access the read and/or write control block issued by the second channel controller 340. According to an aspect of the present invention, the register 350 includes an operating register block, an interface parameter block, and a protocol structure block to quickly read and/or write control data to control the network electronic device 200.

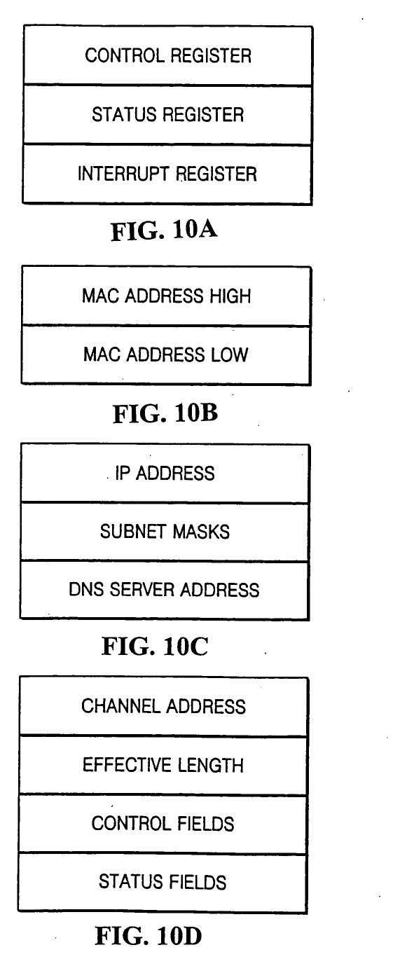

FIGS. 10A through 10D illustrate various examples of the data blocks stored in the register 350. More specifically, FIG. 10A illustrates an operating register block, FIG. 10B illustrates an interface parameter block, FIG. 1C illustrates a TCP/IP structure block, and FIG. 10D illustrates a second channel control block.

The access data storage unit 360 serves as a storage space to implement access to the control data stored in the data storage unit 130.

The interrupt generator 370 generates an interrupt signal and outputs the interrupt signal to the network electronic device 200. An interrupt controller (not shown) of the network electronic device 200 receives the interrupt signal from the interrupt generator 370 and outputs a predetermined control signal to the second channel controller 340 so that the second channel controller 340 reads control packet data to control the network electronic device 200.

The second channel controller 340 withdraws control packet data corresponding to a read control block and transmits the withdrawn control packet data to the network electronic device 200, and/or receives response packet data corresponding to a write control block and outputs the response packet data to a host. More specifically, the read control block includes address information of the data storage unit 130, in which the control packet data is stored, and size information of the control packet data. According to an aspect of the present invention, the second channel controller 340 accesses the read control block stored in the register 350 and outputs packet data corresponding to the address information contained in the read control block to the network electronic device 200. The write control block includes address information of a predetermined storage space in the data storage unit 130, in which the response packet data is to be stored, and size information of the predetermined storage space. Therefore, the second channel controller 340 accesses the write control block stored in the register 350 and controls the control packet data to be stored in the predetermined storage space corresponding to the address information contained in the write control block. Thereafter, the second channel controller 340 controls the response control data stored in the predetermined storage space in the data storage unit 130 to be transmitted to the host.

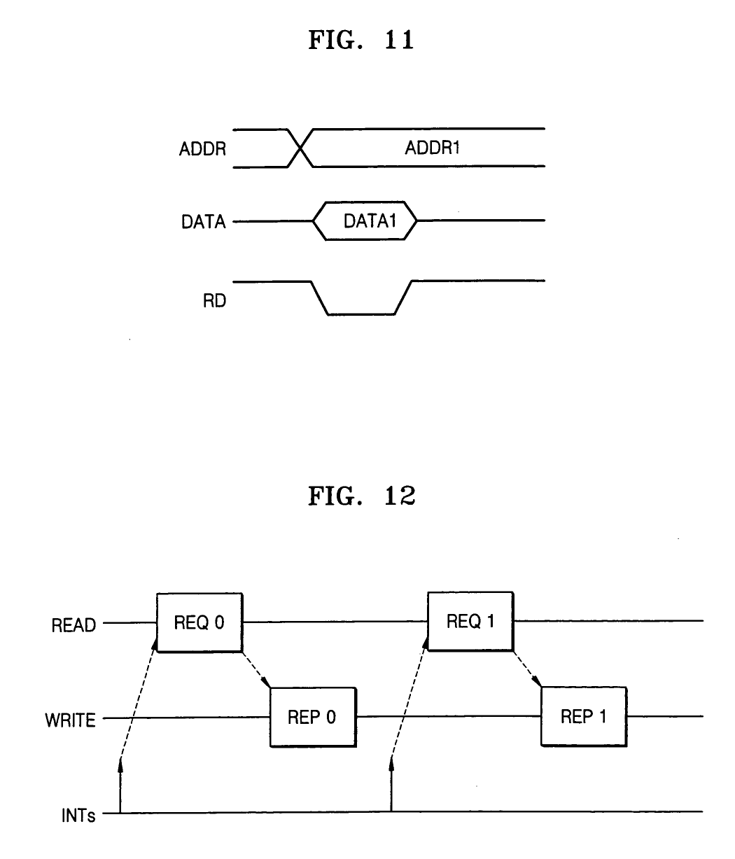

FIG. 11 is a timing diagram to illustrate the transmission of control packet data to control the network electronic device 200 to the network electronic device 200. Referring to FIG. 11, a valid address ADDR1 is provided as address information ADDR because the control packet data can be randomly accessed. Control packet data DATA1 is transmitted to the network electronic device 200 in response to execution of a read command RD.

FIG. 12 is a diagram to illustrate the transmission of control packet data and response packet data to the network electronic device 200 in response to an interrupt signal INTs. When the interrupt signal INTs is generated, the second channel controller 340 transmits control packet data REQ0 and REQ1 to the network electronic device 200. Thereafter, the second channel controller 340 receives response packet data REP0 and REP1 from the network electronic device 200, and the response packet data REP0 and REP1 are stored in a predetermined storage space in the data storage unit 130.

A data interfacing method of a network electronic device according to an aspect of the present invention will now be described more fully with reference to the accompanying drawings.

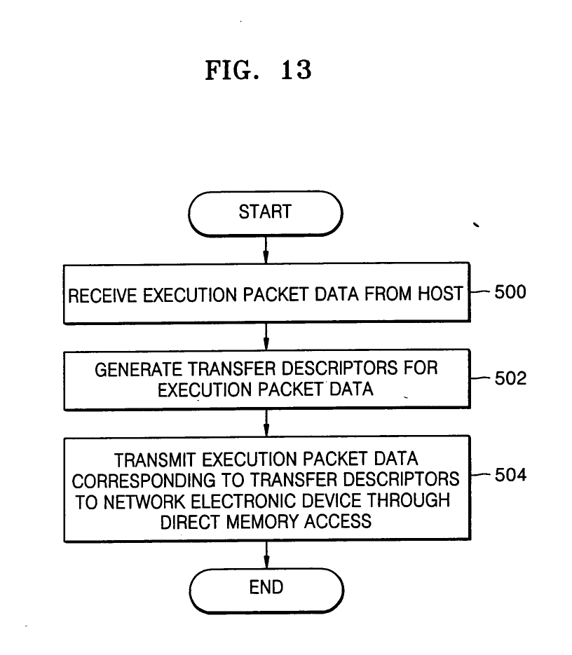

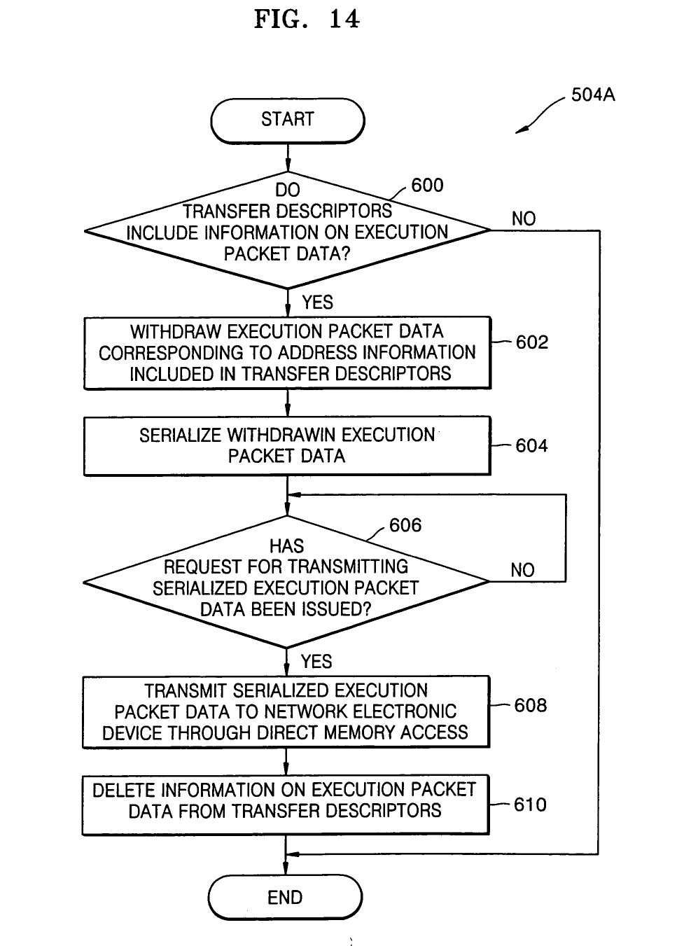

FIG. 13 is a flowchart of a data interfacing method of a network electronic device 200 according to an aspect of the present invention. Referring to FIG. 13, execution packet data that executes functions of the network electronic device 200 is received from a host via a network in operation 500. More specifically, the execution packet data is input to the data receiving unit 110 and stored in the data storage unit 130.

In operation 502, transfer descriptors are generated for the execution packet data. Each transfer descriptor has respective address and size information of the execution packet data, control information, and adjacent transfer descriptor information on respective adjacent transfer descriptors.

In operation 504, the execution packet data corresponding to the generated transfer descriptors are transmitted to the network electronic device 200 through direct memory access.

FIG. 14 is a detailed flowchart of operation 504 of FIG. 13. Referring to FIG. 14, it is checked whether the transfer descriptors include information of the execution packet data in operation 600. The information of the execution packet data includes the information contained in each of the transfer descriptors, such as the address information and size information of the execution packet data, the control information, and the adjacent transfer descriptor information. Upon determining that the transfer descriptors are determined not to have such information, the entire data interfacing operation ends.

However, upon determining that the transfer descriptors are determined to have such information, execution packet data corresponding to the address information contained in each the transfer descriptors is withdrawn in operation 602. More specifically, the first channel controller 310 withdraws the packet data corresponding to the address information contained in each of the transfer descriptors from the data storage unit 130.

In operation 604, the withdrawn packet data is serialized. More specifically, the serialization processor 320 serializes the withdrawn packet data.

In operation 606, it is determined whether a request to transmit the serialized packet data has been issued by the network electronic device 200. Upon determining that no such request has been issued by the network electronic device 200, operation 606 is repeated. However, upon determining that the request to transmit the serialized packet data has been issued by the network electronic device 200, the serialized packet data is transmitted to the network electronic device 200 in operation 608. More specifically, the direct memory access controller 330 transmits the serialized packet data to the network electronic device through direct access memory.

In operation 610, the information of the execution packet data is removed from the transfer descriptors in order to write information of new execution packet data in the transfer descriptors.

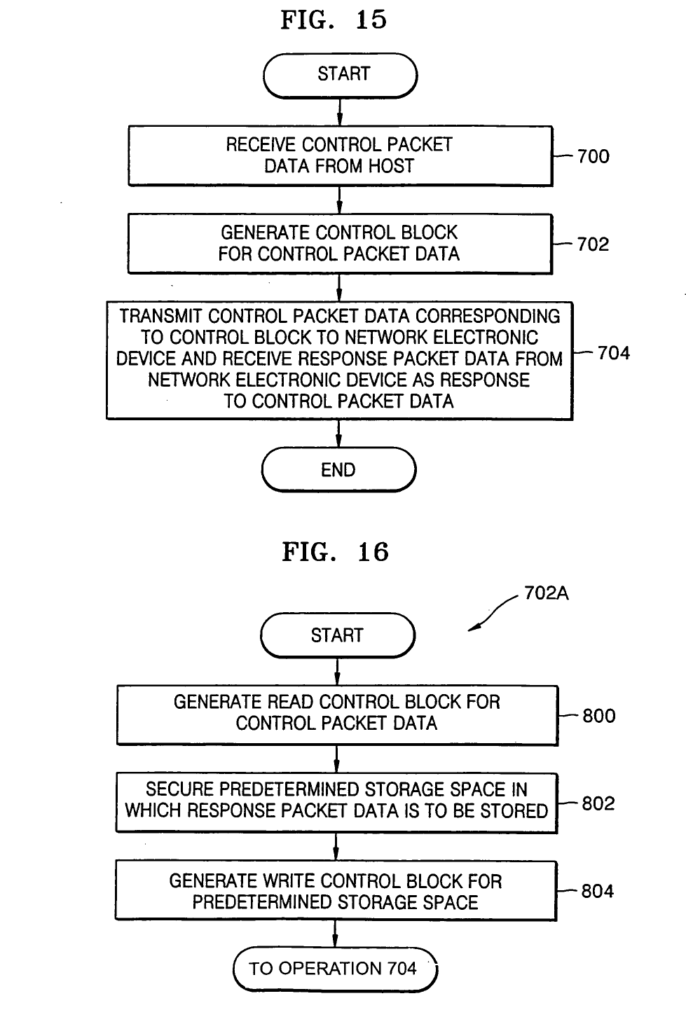

FIG. 15 is a flowchart of a data interfacing method of a data electronic device 200 according to another aspect of the present invention. Referring to FIG. 15, control packet data to control the network electronic device 200 is received from a host via a network in operation 700. More specifically, the control packet data is input to the data receiving unit 110 and stored in the data storage unit 130.

In operation 702, a control block for the control packet data is generated.

FIG. 16 is a detailed flowchart of operation 702 of FIG. 15. Referring to FIG. 16, a read control block having address and size information of the control packet data, control information, and transmission state information is generated. An example of the read control block is illustrated in FIG. 5(A). The read control block is generated by the network processing unit 140.

In operation 802, a predetermined storage space, in which the control packet data is to be stored, is prepared in, for example, the data storage unit 130.

In operation 804, a write control block having address information and size information of the predetermined storage space, control information, and transmission state information is generated. An example of the write control block is illustrated in FIG. 5B. The write control block is generated by the network processing unit 140.

Referring to FIG. 15 again, in operation 704, control packet data corresponding to the control block generated in operation 800 or 804 is transmitted to the network electronic device 200, and response packet data is received from the network electronic device 200 in response to the control packet data.

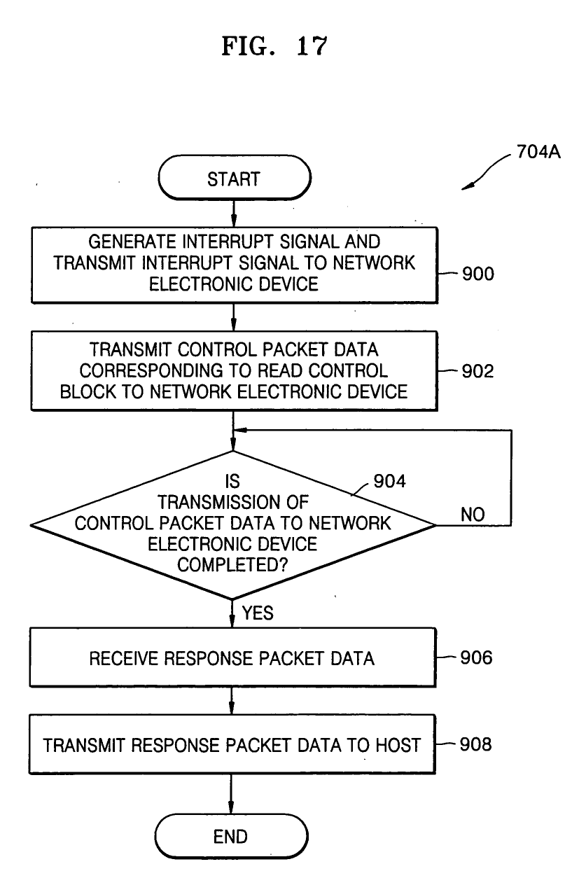

FIG. 17 is a detailed flowchart of operation 704 of FIG. 15. Referring to FIG. 17, an interrupt signal is generated and transmitted to the network electronic device 200 in operation 900.

In operation 902, control packet data corresponding to the read control block is transmitted to the network electronic device 200. More specifically, control packet data corresponding to the address information contained in the read control block is transmitted to the network electronic device 200.

In operation 904, it is determined whether the transmission of the control packet data to the network electronic device 200 is completed. Upon determining that the transmission of the control packet data to the network electronic device 200 is yet to be completed, operation 904 is continuously performed.

However, Upon determining that the transmission of the control packet data to the network electronic device 200 is completed, response packet data corresponding to the control packet data is received and stored in the predetermined storage space in operation 906 by using the address information contained in the write control block.

In operation 908, the response packet data is transmitted to the host.

As described above, according to an aspect of the present invention, it is possible to exchange data between a network electronic device and a host at high speed by reducing local bus bandwidth occupancy rates of the network electronic device and the data interfacing apparatus. In addition, it is possible to simplify codes and minimize header information by using a streaming channel through direct memory access to skip pretreatment operations to interpret command languages.

Although a few embodiments of the present invention have been shown and described, it would be appreciated by those skilled in the art that changes may be made in this embodiment without departing from the principles and spirit of the invention, the scope of which is defined in the claims and their equivalents.

1. A data interfacing apparatus of a network electronic device connected with a host via a network, comprising:
a data receiving unit to receive execution packet data to execute functions of the network electronic device and control packet data to control the network electronic device from the host via the network;
a data storage controlling unit to control storage of the execution packet data and/or the control packet data;
a data storage unit to store the execution packet data and/or the control packet data;
a network processing unit to generate transfer descriptors of the execution packet data stored in the data storage unit and/or to generate a control block of the control packet data stored in the data storage unit; and
an interface controlling unit to transmit packet data corresponding to the transfer descriptors to the network electronic device through direct memory access and/or to transmit packet data corresponding to the control block to the network electronic device, and to receive response packet data from the network electronic device as a response to the control packet data.

2. The data interfacing apparatus according to claim 1, wherein the network processing unit generates the transfer descriptors including address information, size information, and control information corresponding to the execution packet data, and adjacent transfer descriptor information corresponding to adjacent transfer descriptors.

3. The data interfacing apparatus according to claim 2, wherein the network processing unit generates a read control block having address information, size information, control information, and transmission state information of the control packet data, and/or generates a write control block having address information and size information of a storage space in which the response packet data is to be stored, control information, and transmission state information.

4. The data interfacing apparatus according to claim 3, wherein the network processing unit secures the storage space in which the response packet data is to be stored in the data storage unit before transmitting the control packet data to the network electronic device.

5. The data interfacing apparatus according to claim 4, wherein the interface controlling unit includes a local bus and comprises:
a local bus controller to control transmission of data via the local bus;
a first channel controller to check the transfer descriptors, to withdraw the execution packet data corresponding to the address information contained in each of the transfer descriptors from the data storage unit, and to output the withdrawn execution packet data;
a serialization processor to serialize the withdrawn execution packet data;
a direct memory access controller to transmit the serialized execution packet data to the network electronic device through direct memory access;
a second channel controller to withdraw the control packet data corresponding to the read control block and transmit the withdrawn control packet data to the network electronic device, and/or receive the response packet data corresponding to the write control block and output the response packet data to the host;
an interrupt generator to generate an interrupt signal and output the interrupt signal to the network electronic device;
a register to store the read control block and/or the write control block; and
an access data storage unit to serve as a storage space to store the control packet data stored in the data storage unit.

6. The data interfacing apparatus according to claim 5, wherein the register comprises:
an operating register block, an interface parameter block, and/or a protocol structure block.

7. A data interfacing method of a network electronic device connected with a host, comprising:
receiving execution packet data to execute functions of the network electronic device from the host;
generating transfer descriptors of the execution packet data; and
transmitting the execution packet data corresponding to the transfer descriptors to the network electronic device through direct memory access.

8. The data interfacing method according to claim 7, wherein the generating the transfer descriptors of the execution packet data comprises:
generating the transfer descriptors having address information, size information, and control information corresponding to the execution packet data and adjacent transfer descriptor information corresponding to adjacent transfer descriptors.

9. The data interfacing method according to claim 8, wherein the transmitting the execution packet data corresponding to the transfer descriptors comprises:
determining whether the transfer descriptors include the address information, the size information, the control information, and the adjacent transfer descriptor information;
withdrawing the execution packet data corresponding to the address information contained in each of the transfer descriptors upon determining that the transfer descriptors have the information on the execution packet data;
serializing the withdrawn execution packet data;
determining whether a request to transmit the serialized execution packet data has been issued by the network electronic device;
transmitting the serialized execution packet data to the network electronic device through direct memory access upon determining that the request to transmit the serialized execution packet data is issued by the network electronic device; and
deleting the address information, the size information, the control information, and the adjacent transfer descriptor information from each of the transfer descriptors.

10. A data interfacing method of a network electronic device connected with a host, comprising:
receiving control packet data to control the network electronic device from the host;
generating a control block of the control packet data; and
transmitting the control packet data corresponding to the control block to the network electronic device and receiving response packet data from the network electronic device as a response to the control packet data.

11. The data interfacing method according to claim 10, wherein the generating the control block of the control packet data comprises:
generating a read control block having address information, size information, control information, and transmission state information of the control packet data;
securing a storage space to which the response packet data is to be stored; and
generating a write control block having address and size information of the predetermined storage space, control information, and transmission state information.

12. The data interfacing method according to claim 11, wherein the transmitting the control packet data corresponding to the control block to the network electronic device and receiving response packet data from the network electronic device comprises:
generating an interrupt signal and transmitting the interrupt signal to the network electronic device;
transmitting the control packet data corresponding to the read control block to the network electronic device;
determining whether the transmission of the control packet data is completed;
storing the response packet data in the predetermined storage space upon determining that the transmission of the control packet data is determined to be completed; and
transmitting the stored response packet data to the host.

13. The data interfacing apparatus according to claim 1, wherein the network electronic device is one of a printer, a facsimile machine, and a multi-functional device.

14. The data interfacing apparatus according to claim 1, wherein the data receiving unit receives the control packet data using a simple network management protocol.

15. The data interfacing apparatus according to claim 1, wherein the data receiving unit receives the execution packet data using a buffer.

16. The data interfacing apparatus according to claim 2, wherein the network processing unit removes the execution packet data corresponding to the address information from the transfer descriptors when the execution packet data has been transmitted to the network electronic device.

17. The data interfacing method according to claim 7, wherein the network electronic device is one of a printer, a facsimile machine, and a multi-functional device.

18. The data interfacing apparatus according to claim 5, wherein when local bus bandwidth occupancy rates of the network electronic device and the data interfacing apparatus is reduced, data transmission between the network electronic device and the data interfacing apparatus increases.

19. The data interfacing apparatus according to claim 1, wherein the data storage unit is a dynamic random access memory.

20. The data interfacing apparatus according to claim 2, wherein the network processing unit generates a chain of transfer descriptors connected to one another.

21. The data interfacing apparatus according to claim 5, wherein the local bus controller controls the transmission of the execution packet data to the network electronic device to allow the execution packet data to occupy the local bus.

22. The data interfacing apparatus according to claim 5, wherein the serialized execution packet data is transmitted over a streaming channel.

23. The data interfacing apparatus according to claim 22, wherein the network electronic device transmits transmission allowance information to indicate whether access is allowed to the direct memory access controller, and
the direct memory access controller receives the transmission allowance information from the network electronic device and transmits the serialized execution packet data to the network electronic device through direct memory access.

24. The data interfacing apparatus according to claim 5, wherein the serialization processor is a first in first out memory and serializes the execution packet data in an order the execution packet data is received.

25. A data interfacing method of a network electronic device, comprising:
receiving execution packet data to execute functions of the network electronic device and receiving control packet data to control the network electronic device;
generating transfer descriptors of the execution packet data and a control block of the control packet data; and
transmitting the execution packet data corresponding to the transfer descriptors and the control packet data corresponding to the control block to the network electronic device through direct memory access.

26. The data interfacing method according to claim 25, wherein the generated transfer descriptors include address information, size information, and control information corresponding to the execution packet data, and adjacent transfer descriptor information corresponding to adjacent transfer descriptors.

27. The data interfacing method according to claim 26, further comprising:
removing execution packet data corresponding to address information of the execution packet data;
serializing the removed execution packet data; and
transmitting the serialized execution packet data to the network electronic device through direct memory access.

28. A data interfacing apparatus of a network electronic device connected with a host, comprising:
a networking processing unit to generate transfer descriptors of execution packet data and a control block of a control packet data; and
an interface controlling unit to transmit packet data of the transfer descriptors and packet data of the control block to the network electronic device, and to receive packet data from the network electronic device, wherein the packet data of the transfer descriptors and packet data of the control block are transmitted through direct memory access.

29. The data interfacing apparatus according to claim 28, wherein the network electronic device is one of a printer, a facsimile machine, and a multi-functional device.

30. The data interfacing apparatus according to claim 28, wherein header information of each packet data is minimized using a streaming channel.
